(19) United States
(12) Patent Application Publication
(10) Pub. No.: US 2012/0063079 A1
(43) Pub. Date: Mar. 15, 2012

(54) ELECTRONIC DEVICE

(75) Inventor: WANG-HUNG YEH, Tu-Cheng (TW)

(73) Assignee: HON HAI PRECISION INDUSTRY CO., LTD., Tu-Cheng (TW)

(21) Appl. No.: 13/167,898

(22) Filed: Jun. 24, 2011

(30) Foreign Application Priority Data
Sep. 15, 2010 (TW) 99131134

(51) Int. Cl. G06F 1/16

(52) U.S. Cl. 361/679.4

(57) ABSTRACT

An electronic device includes a body having a rear wall, and an I/O port assembly rotatably connected to the body. A plurality of interface ports are arranged at the I/O port assembly. The I/O port assembly is rotatable around an axis from a first position to a second position. When the I/O port assembly rotates to the first position, the interface ports face the rear wall and are hidden, and when the I/O port assembly rotates to the second position, the interface ports are opposite to the rear wall and are exposed.

### BACKGROUND

1. Technical Field

The present disclosure relates to electronic devices, and particularly to an electronic device having a rotatable I/O port assembly.

2. Description of Related Art

A notebook computer has several interfaces arranged in its sidewalls for electrically connecting peripheral devices. However, when the interfaces are not in use, they accumulate dust and grime and made prove unreliable when in use.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout views.

FIG. 1 is a perspective view of an electronic device in accordance with an embodiment; the electronic device has an I/O port assembly with interface ports.

FIG. 2 is a perspective view showing the electronic device of FIG. 1 with the interface ports being exposed.

FIG. 3 is a disassembled perspective view of the electronic device of FIG. 2.

FIG. 4 is a perspective view showing the electronic device of FIG. 1 being supported by the I/O port assembly.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

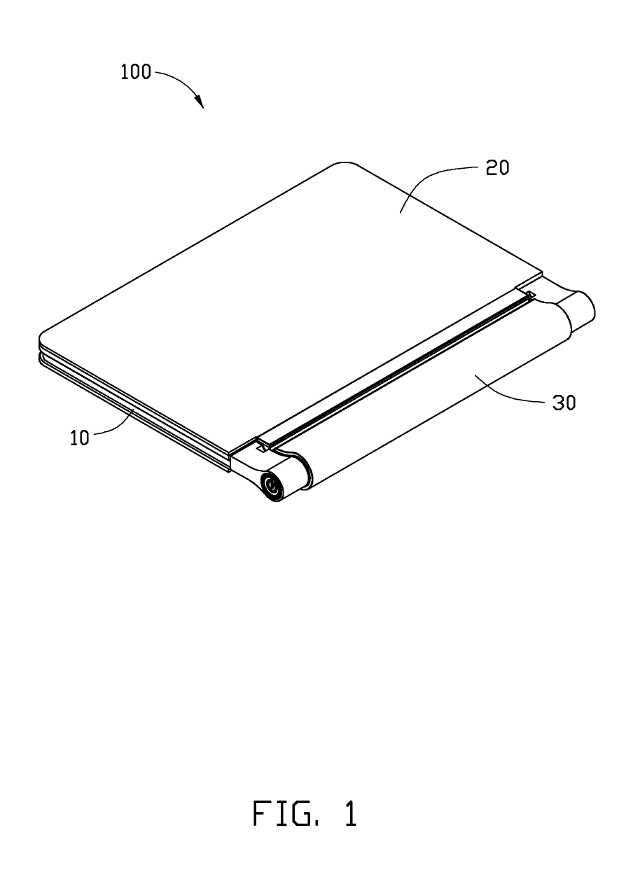

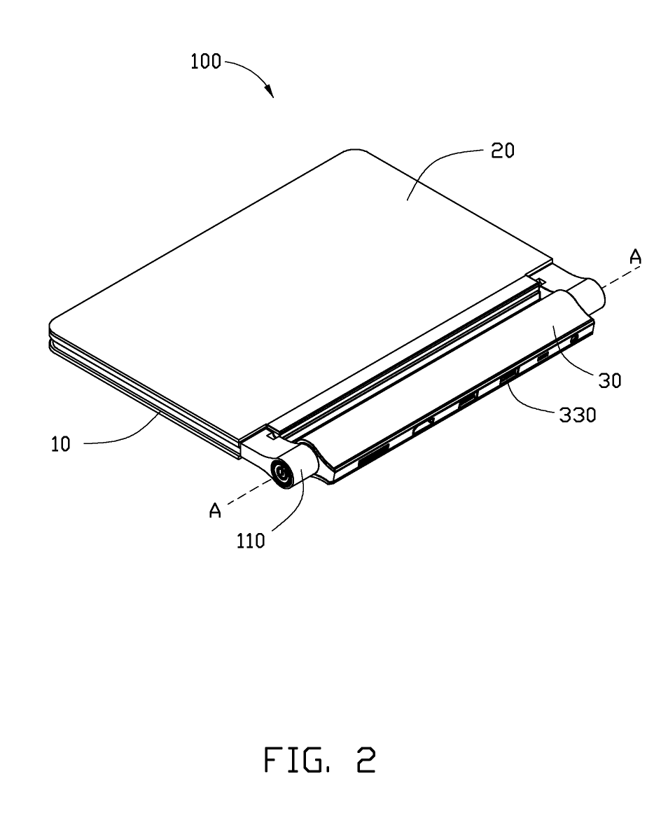

Referring to FIG. 1, an electronic device 100 in accordance with an embodiment is shown. The electronic device 100 includes a body 10, a cover 20, and an I/O port assembly 30. The cover 20 is rotatably coupled to the body 10. The I/O port assembly 30 is rotatably connected to the body 10. A plurality of interface ports 330 (see FIG. 2) are arranged on the I/O port assembly 10 for connecting peripherals (not shown) to the electronic device 100. The electronic device 100 can be a notebook computer, a PDA or other portable electronic devices. In the embodiment, the electronic device 100 is a notebook computer. The electronic device 100 may also be a tablet computer or other electronic devices.

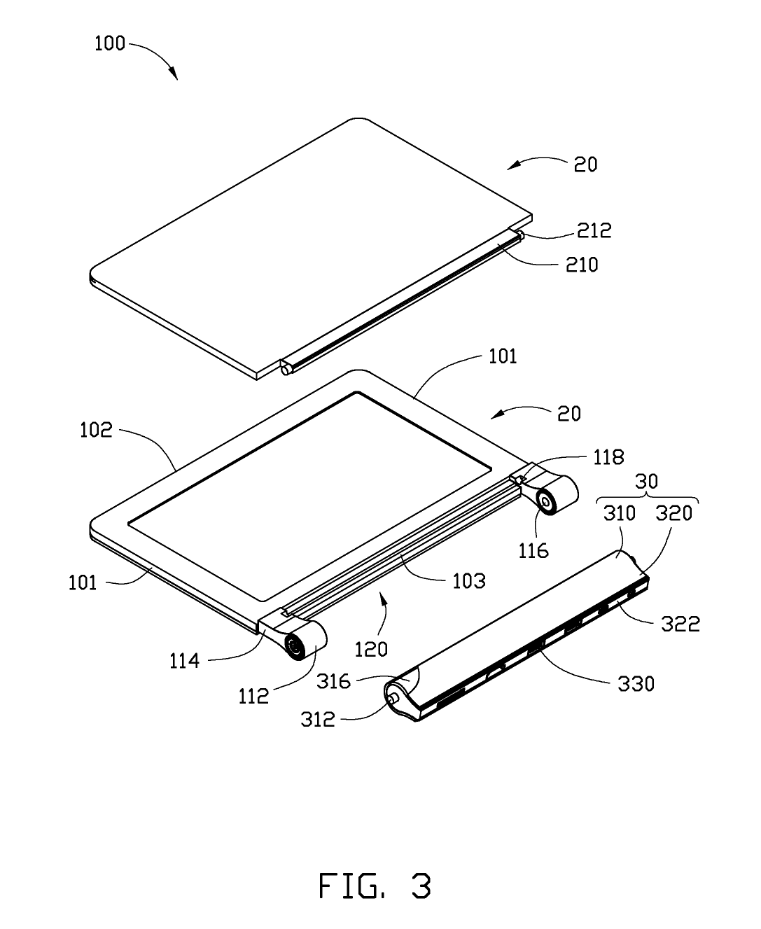

Referring further to FIGS. 2-3, the body 10 may be plate-like and include components, such as motherboard, processor, hard disk, and other components (not shown) for operating the electronic device 100 therein. The body 10 may be substantially rectangular. The body 10 includes two opposite sidewalls 101, a front wall 102 and a rear wall 103 opposite to the front wall 102. The front wall 102 and the rear wall 103 are perpendicularly connected to the sidewalls 101. Two arms 110 respectively and perpendicularly extend from opposite ends of the rear wall 103 along a direction away from the rear wall 103. The arms 110 and the rear wall 103 cooperatively define a receiving recess 120. The receiving recess 120 is substantially U-shaped, and is used to receive the I/O port assembly 30.

Each arm 110 includes a head portion 112 and a connecting portion 114 for connecting the head portion 112 to the body 10. The head portion 112 is substantially cylindrical. The diameter of the head portion 112 is larger than the thickness of the body 10. The joint portion of the connecting portion 114 and the head portion 112 has an arcuate surface acting as a transition surface between the head portion 112 and the connecting portion 114, such that the connection portion 114 transits smoothly to the head portion 112. Each head portion 112 defines an axial hole 116 having an axis A. The axis A is substantially parallel to the rear wall 103. An end of each connecting portion 114 adjacent to the body 10 defines a pivot hole 118. The cover 20 is pivotally coupled to the body 10 via first pivoting shafts 212 pivotally and respectively disposed in the pivot holes 118.

The cover 20 is substantially rectangular. The size of the cover 20 is substantially equal to that of the body 10 such that the cover 20 can cover the top of the body 10 wholly. A strip-shaped connecting member 210 is arranged on a rear side of the cover 20. The connecting member 210 extends in a direction parallel to the rear side of the cover 20. The length of the connecting member 210 is slightly less than the distance between the arms 110. The two first pivoting shafts 212 protrude from opposite ends of the connecting member 210 respectively. The two first pivoting shafts 212 are rotatably received in the pivot holes 118 respectively, whereby the cover 20 is pivotally coupled to the body 10. In the embodiment, the cover 20 acts as a display device of the electronic device 100 with a display screen defined in a side facing the body 10, while the body 10 acts as a host computer.

The cross-section of the I/O port assembly 30 is similar to that of the arms 110. The I/O port assembly 30 includes a cylindrical portion 310 and a protruding portion 320. The cylindrical portion 310 may be hollow and define a cylindrical chamber therein. A rechargeable battery 316 may be installed in the cylindrical portion 310 for supplying electrical power to the electronic device 100. The protruding portion 320 protrudes radially from a side of the cylindrical portion 310, such that the protruding portion 320 is substantially off-centered relative to the axis A. Two second pivoting shafts 312 protrude from opposite ends of the cylindrical portion 310 respectively. The second pivoting shafts 312 are rotatably received in the axis holes 116 respectively, such that the I/O port assembly 30 is rotatably coupled to the arms 110 and is capable of rotating around the axis A. The protruding portion 320 includes an end surface 322 opposite to the cylindrical portion 310. The distance between the end surface 322 and the axis A is larger than the thickness of the body 10. Such that, when the I/O port assembly 30 is rotated around the axis A to a position where the end surface 322 faces down, the I/O assembly 30 can act as a stand for supporting the body 10 to provide the body 10 an elevation angle. A plurality of interface ports 330, such as USB ports, video ports, audio ports, or power ports, is arranged on the end surface 322.

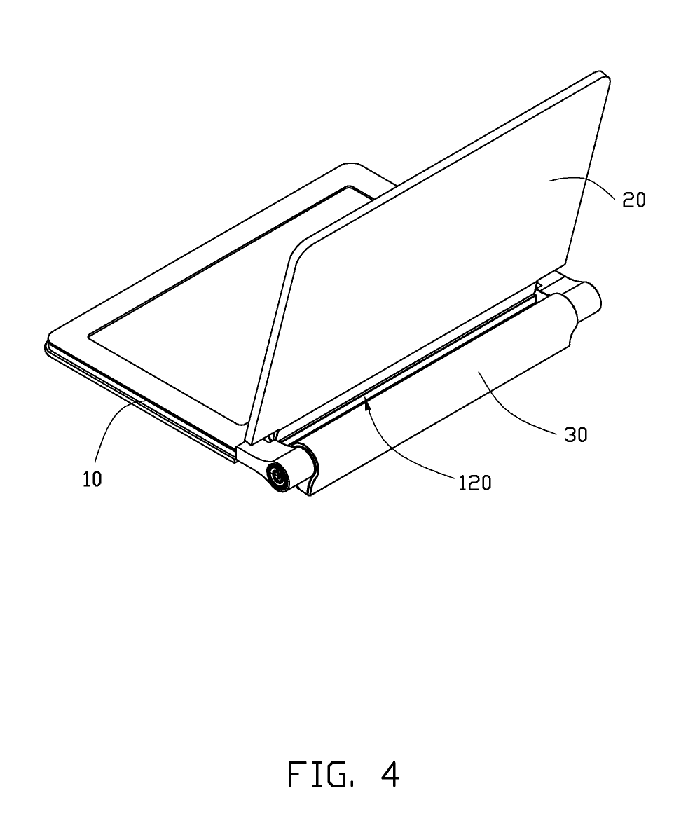

Referring again to FIG. 1, when the I/O port assembly 30 rotates to a position where the end surface 322 faces the rear wall 103 of the body 10, the interface ports 330 are covered by the rear wall 103, and the I/O port assembly is substantially coplanar with the body 10. Referring to FIG. 4, when the I/O port assembly 30 rotates to make the end surface 330 resist against a supporting surface, an end of the body 10 adjacent to the I/O port assembly 30 is elevated. Thus, the I/O port assembly 30 acts as a stand for supporting the electronic device 100 at an angle with a supporting surface.

Referring again to FIG. 2, when the I/O port assembly 30 rotates to a position where the end surface 330 is opposite to the rear wall 103, the interface ports 330 are exposed, and peripherals can be electrically connected to the electronic device 100 via the interface ports 330.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An electronic device, comprising:
a body having a rear surface; and
an I/O port assembly rotatably connected to the body;
wherein the I/O port assembly is rotatable relative to the body around an axis, the axis is parallel to the rear surface, and at least one interface port is arranged on an end surface of the I/O port assembly parallel to the axis.

2. The electronic device of claim 1, wherein the I/O port assembly is rotatably connected to a rear wall of the body, the rear surface is the rear wall.

3. The electronic device of claim 2, wherein the I/O port assembly rotates to a position where the end surface thereof faces the rear wall of the body to hide the at least one interface port, and the I/O port assembly rotates to a position where the end surface thereof is opposite to the rear wall of the body to expose the at least one interface port.

4. The electronic device of claim 3, wherein the I/O port assembly includes a cylindrical portion having the axis and a protruding portion extending from the cylindrical portion, the protruding portion having the end surface opposite to the cylindrical portion.

5. The electronic device of claim 4, wherein the end surface is off-centered from the axis.

6. The electronic device of claim 4, wherein a distance between the end surface and the axis is larger than the thickness of the body.

7. The electronic device of claim 4, wherein the cylindrical portion further defines a chamber for accommodating a battery for charging the electronic device.

8. The electronic device of claim 2, wherein two arms protrude from two opposite ends of the rear wall, the I/O port assembly is rotatably connected to body via the arms.

9. An electronic device, comprising:
a body having a rear wall; and
an I/O port assembly rotatably connected to the body, at least one interface port arranged at the I/O port assembly, the I/O port assembly rotatable around an axis from a first position to a second position;
wherein when the I/O port assembly rotates to the first position, the at least one interface port faces the rear wall and is hidden; when the I/O port assembly rotates to the second position, the at least one interface port opposite to the rear wall and is exposed.

10. The electronic device of claim 9, wherein the I/O port assembly includes a cylindrical portion having the axis and a protruding portion extending from the cylindrical portion, the protruding portion having an end surface opposite to the cylindrical portion, the at least one interface port is arranged at the end surface.

11. The electronic device of claim 10, wherein the end surface is off-centered from the axis.

12. The electronic device of claim 11, wherein a distance between the end surface and the axis is larger than the thickness of the body.

13. The electronic device of claim 12, wherein the I/O port assembly is rotatable to third position different from the first and second portions, and is used for supporting the electronic device when the I/O port assembly rotates to the third position.

14. The electronic device of claim 9, wherein two arms protrude from two opposite ends of the rear wall, the I/O port assembly is rotatably connected to body via the arms.

15. The electronic device of claim 10, wherein the cylindrical portion further defines a chamber for accommodating a battery for charging the electronic device.

16. An electronic device, comprising:
a body; and
an I/O port assembly electrically and rotatably connected to the body for electrically connecting the body to at least one peripheral, the I/O port assembly comprising a surface with at least one interface port configured thereon;
wherein the I/O port assembly is capable of rotating relative to the body to a first position where the surface is covered by the body and a second position where the surface is exposed from the body.

17. The electronic device of claim 16, wherein the I/O port assembly is capable of rotating relative to the body to a third position where the surface faces down, and acting as a stand for supporting the body in the third position.

18. The electronic device of claim 16, wherein the I/O port assembly is substantially coplanar with the body when the I/O port assembly is rotated to the first position.

19. The electronic device of claim 16, wherein two arms protrude horizontally from two opposite ends of a rear side of the body and define a receiving recess, the I/O port assembly is rotatably disposed in the receiving recess.

20. The electronic device of claim 16, wherein the I/O port assembly further defines a chamber for accommodating a battery for charging the electronic device.
